(19) United States
(12) Patent Application Publication
(10) Pub. No.: US 2022/0203788 A1
(43) Pub. Date: Jun. 30, 2022

(54) SUSPENSION ARM FOR VEHICLES AND METHOD FOR PRODUCING SAME

(71) Applicant: ILJIN CO., LTD., Gyeongju-si Gyeongsangbuk-do (KR)

(72) Inventors: Se Woong JEONG, Ulsan (KR); Ig Jin KWON, Daegu (KR); Young Chun LEE, Suwon-si Gyeonggi-do (KR); Ju Hyoung CHO, Pohang-si Gyeongsangbuk-do (KR)

(73) Assignee: ILJIN CO., LTD., Gyeongju-si Gyeongsangbuk-do (KR)

(21) Appl. No.: 17/696,940

(22) Filed: Mar. 17, 2022

Related U.S. Application Data
(63) Continuation of application No. PCT/KR2020/012670, filed on Sep. 18, 2020.

(30) Foreign Application Priority Data
Sep. 18, 2019 (KR) 10-2019-0114987

(51) Int. Cl. B60G 7/00; B60G 7/02; B22C 9/02; B22D 17/20

(52) U.S. Cl. CPC B60G 7/001; B60G 7/008; B33Y 80/00; B22C 9/02; B22D 17/2084; B60G 7/02

(57) ABSTRACT

There is provided a vehicular suspension arm used for a suspension device of a vehicle. The vehicular suspension arm according to an embodiment of the present invention may comprise: a body portion constituting a basic body of the vehicular suspension arm; and a mounting portion formed in one end of the body portion and configured to connect the vehicular suspension arm to a wheel or a vehicle body of the vehicle, wherein the body portion may have a closed-box-section structure in which a hollow inner space is defined, and the closed-box-section structure may be configured such that the body portion is formed to integrally extend around the hollow inner space.

### CROSS-REFERENCE TO RELATED APPLICATIONS

This application is a continuation of International Application No. PCT/KR2020/012670 filed on Sep. 18, 2020, which claims priority to Korean Patent Application No. 10-2019-0114987 filed on Sep. 18, 2019, the entire contents of which are herein incorporated by reference.

### TECHNICAL FIELD

The present invention relates to a suspension arm used for a suspension device of a vehicle and a manufacturing method therefor, and more particularly to a suspension arm for a vehicle, which is configured to form a body portion of the suspension arm to have a hollow closed-cross-section structure for reducing a weight thereof and ensuring sufficient rigidity required for the suspension device, and a manufacturing method therefor.

### BACKGROUND ART

A vehicular suspension device is a device for connecting a vehicle body and a wheel, and comprises a spring for absorbing vibration or impact transferred from a road surface to the vehicle body, a shock absorber for controlling the operation of the spring, and a suspension arm or a suspension link for controlling the operation of the wheel, and a like.

Among these, the suspension arm is configured such that one side thereof is connected to the wheel via a ball joint and another side thereof is connected to the vehicle body via a cross member, a sub-frame or the like, so that the wheel is supported on the vehicle body. With this configuration, the suspension arm properly controls toe-in of the wheel according to the driving situation of the vehicle. This improves the straight driving property and steering stability of the vehicle. The suspension arm may be classified into a lower arm and an upper arm according to mounting positions thereof.

Typically, such a vehicular suspension arm is formed by processing a metal-based material by casting, press-machining, or the like to ensure the rigidity required for the vehicular suspension arm. For example, the vehicular suspension arm may be manufactured by injecting a steel or an aluminum material which remains in a molten state into a mold and subsequently solidifying the same. Alternatively, the vehicular suspension arm may be manufactured by press-machining a steel plate material to produce an upper plate and a lower plate, and subsequently welding the upper plate and the lower plate or by bending one end portion of the steel plate material to form a flange.

However, the vehicular suspension arm used previously is increased in weight due to the heavy metallic material and requires a large number of manufacturing processes. This may increase the manufacturing time and cost. In addition, unintended deformation may occur at the time of welding the metallic material and sufficient rigidity may not be secured.

For example, referring to FIGS. 1 and 2, there is exemplarily illustrated a vehicular suspension arm (lower arm) in the related art, which is manufactured by welding press-formed upper and lower plates. As illustrated in FIG. 1, a vehicular suspension arm 10 is configured such that one side thereof is coupled to a knuckle 35 or the like, which is connected to a wheel 30 of the vehicle, via a ball join 20, and other sides thereof are coupled to a vehicle body 40 via bushings 22 and 24, or the like. Thus, the vehicular suspension arm 10 performs a function of supporting the wheel 30 of the vehicle with respect to the vehicle body 40.

In addition, the suspension arm 10 for a vehicle in the related art illustrated in FIGS. 1 and 2 is formed by welding an upper plate 12 and a lower plate 14, which are separately manufactured (see reference numeral 18), in a state in which they are brought into contact with each other, to form an empty space 16 therebetween. By the empty space 16 formed between the upper plate 12 and the lower plate 14, a closed box section (box-like cross section) is formed, thus improving rigidity while reducing weight.

However, in the vehicular suspension arm 10 formed in this manner, the closed-box-section structure may be formed locally merely in some portions of the vehicular suspension arm 10, which makes it difficult to ensure overall sufficient rigidity. Further, the upper plate 12 and the lower plate 14 are welded along the periphery of the vehicular suspension arm 10 to form the closed-box-section structure. This may reduce manufacturing efficiency, may cause unintended deformation in a product at the time of welding, may result in a decrease in rigidity. As a result, the performance of the product may be degraded.

### SUMMARY

### Technical Problem

The present invention aims to solve the above-mentioned matters of a suspension arm for a vehicle, and to provide a vehicular suspension arm capable of being more easily manufactured while implementing a reduction in weight and sufficiently ensuring rigidity required for the vehicular suspension arm by forming a complete hollow closed-box-section structure in a body portion of the vehicular suspension arm (in which the closed-box-section structure is directly formed by the body portion body without performing welding or the like).

### Technical Solution

Representative configurations of the present invention to achieve the above objects are described below.

According to an embodiment of the present invention, there is provided a vehicular suspension arm used for a suspension device of a vehicle. The suspension arm according to an embodiment of the present invention may comprise: a body portion constituting a basic body of the suspension arm; and a mounting portion formed in one end of the body portion and configured to connect the suspension arm to a wheel or a vehicle body of the vehicle, wherein the body portion may have a closed-box-section structure in which a hollow inner space is defined, and the closed-box-section structure may be configured such that the body portion is formed to integrally extend around the hollow inner space.

According to an embodiment of the present invention, the closed-box-section structure may be formed throughout the body portion.

According to an embodiment of the present invention, at least one reinforcing rib may be provided in the hollow inner space defined inside the body portion.

According to an embodiment of the present invention, the at least one reinforcing rib may be formed in a bar shape that extends between inner circumferential surfaces of the body portion.

According to an embodiment of the present invention, the at least one reinforcing rib may comprise a plurality of reinforcing ribs provided in the hollow inner space defined inside the body portion to form a lattice structure inside the hollow inner space.

According to an embodiment of the present invention, the at least one reinforcing rib may be formed in the bar shape that extends at an angle ranging from 5 degrees to 175 degrees with respect to the inner circumferential surface of the body portion.

According to an embodiment of the present invention, the mounting portion may comprise at least one wheel-side mounting portion connected to the wheel and at least one vehicle-body-side mounting portion connected to the vehicle body, and the body portion and the mounting portion may be formed to have a single integrated structure.

According to an embodiment of the present invention, the suspension arm may be formed by injecting a molten metallic material into a mold in a state in which a sand core formed to have a structure corresponding to the suspension arm is mounted to the mold.

According to an embodiment of the present invention, the molten metallic material forming the suspension arm may be aluminum.

According to an embodiment of the present invention, there is provided a method of manufacturing a vehicular suspension arm used for a suspension device of a vehicle. The manufacturing method of the suspension arm according to an embodiment of the present invention may comprise: a sand core preparation operation of forming a sand core serving as a basic frame; a sand core mounting and suspension arm forming operation of mounting the sand core in a mold and subsequently injecting a molten metallic material into the mold to form the suspension arm; a demolding operation of separating the molded suspension arm from the mold; and a sand removing operation of removing the sand core adhered to the demolded suspension arm.

According to an embodiment of the present invention, in the sand core preparation operation, the sand core may be formed to have at least one through-hole for forming a reinforcing rib, and the reinforcing rib may be formed to extend between inner circumferential surfaces of a body portion of the suspension arm by injecting the molten metallic material into the through-hole.

According to an embodiment of the present invention, in the sand core preparation operation, the sand core may be formed using a 3D printer.

According to an embodiment of the present invention, the sand core mounting and suspension arm forming operation may comprise: inserting the sand core in a recess provided in a lower mold, wherein the recess has a shape corresponding to the sand core; covering the lower mold with an upper mold; and injecting the molten metallic material into the mold to form the suspension arm.

According to an embodiment of the present invention, the molten metallic material injected in the sand core mounting and suspension arm forming operation may be a molten aluminum material.

According to an embodiment of the present invention, in the sand removing operation, the sand core may be removed using any of a vibration mode of applying vibration to remove the sand core, an air injection mode of injecting air to remove the sand core, and a solvent immersion mode of immersing a product in a solution capable of melting the sand core to remove the sand core.

Further, the vehicular suspension arm and the manufacturing method therefor according to the present invention may further comprise other additional configurations without departing from the technical sprit of the present invention.

### Advantageous Effects

In a vehicular suspension arm according to an embodiment of the present invention, a body portion of the vehicular suspension arm is formed to have a hollow closed-box-section structure. Accordingly, it is possible to sufficiently secure rigidity required for the vehicular suspension arm while reducing the weight of the vehicular suspension arm.

Furthermore, the vehicular suspension arm according to an embodiment of the present invention is configured such that a complete hollow closed-box-section structure is formed in the body portion of the vehicular suspension arm using a sand casting without welding over a wide range. This makes it possible to ensure a relatively high rigidity and implement a reduction in weight as compared with a suspension arm for a vehicle in the related art.

Furthermore, the vehicular suspension arm according to an embodiment of the present invention can be manufactured through the sand casting to form the body portion and the mounting portions of the vehicular suspension arm as an integrated one-piece structure. This makes it possible to further improve the rigidity of the vehicular suspension arm.

Furthermore, the vehicular suspension arm according to an embodiment of the present invention is configured such that reinforcing ribs of a lattice structure are provided inside the body portion formed in the hollow closed-box-section structure. This makes it possible to further improve the rigidity of the vehicular suspension arm.

### DESCRIPTION OF DRAWINGS

FIG. 1 exemplarily illustrates a structure of a suspension arm (lower arm) for a vehicle in the related.

FIGS. 2A and 2B exemplarily illustrate a cross-sectional structure of the vehicular suspension arm illustrated in FIG. 1.

FIGS. 3 and 4 exemplarily illustrate a structure of a vehicular suspension arm (upper arm) according to an embodiment of the present invention.

FIG. 5 exemplarily illustrates an exploded perspective view of the vehicular suspension arm according to an embodiment of the present invention.

FIG. 6 exemplarily illustrates a partially cutaway perspective view of the vehicular suspension arm according to an embodiment of the present invention.

FIGS. 7A and 7B exemplarily illustrate a cross-sectional structure of the vehicular suspension arm according to an embodiment of the present invention, taken along lines A-A′ and B-B′ in FIG. 4.

FIG. 8 is a flowchart for exemplarily explaining manufacturing processes that may be used to manufacture the vehicular suspension arm according to an embodiment of the present invention.

FIG. 9 exemplarily illustrates a structure of a sand core that may be used to manufacture the vehicular suspension arm according to an embodiment of the present invention.

FIG. 10 exemplarily illustrates a process of mounting the sand core in a mold and forming a suspension arm to manufacture the vehicular suspension arm according to an embodiment of the present invention.

FIG. 11 exemplarily illustrates a process of forming the vehicular suspension arm according to an embodiment of the present invention by demolding the suspension arm and removing sand after the casting process.

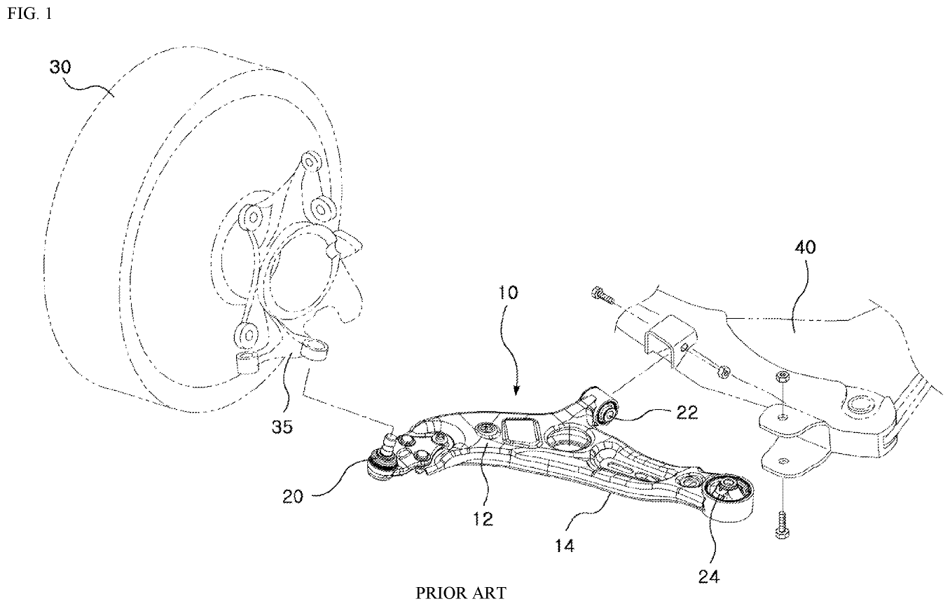

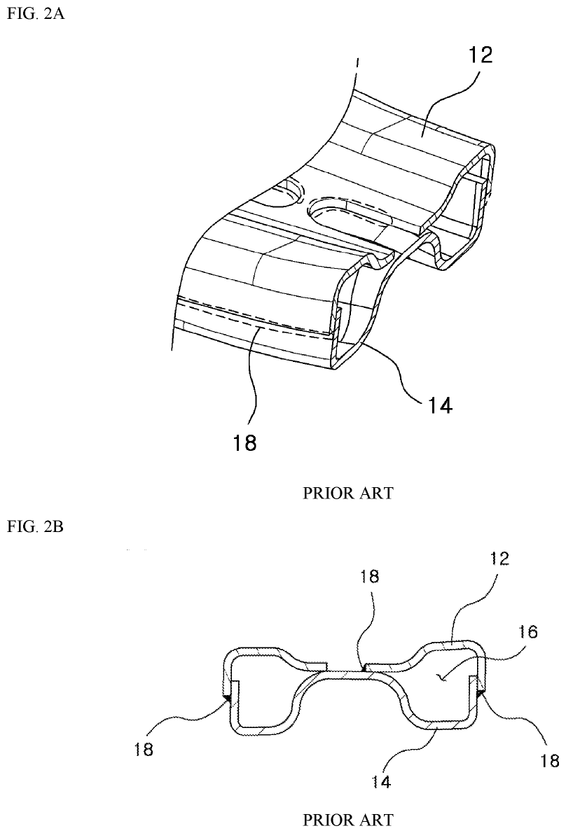

### EXPLANATION OF REFERENCE NUMERALS

100: vehicle suspension arm

200: body portion

210, 220: leg portion

230: joint portion

240: through-bore

250: reinforcing rib

300: mounting portion

310: first mounting portion

320: second mounting portion

330: third mounting portion

340: ball joint

350, 360: bushing

500: sand core

510, 520: sand core leg portion

530: sand core joint portion

540: sand core through-bore

550: through-hole

560: first-mounting-portion forming portion

570: second-mounting-portion forming portion

580: third-mounting-portion forming portion

600: mold

610: lower mold

612: recess

614: protrusion for forming the first mounting portion

620: upper mold

630: inlet

### DETAILED DESCRIPTION

Hereinafter, preferred embodiments of the present invention will be described in detail with reference to the appended drawings to such an extent that the present invention can be readily practiced by those skilled in the art.

Detailed descriptions of parts irrelevant to the present invention will be omitted for the purpose of more clearly describing the present invention. Throughout the specification, the same constituent elements will be described using like reference numerals. In addition, the shapes and sizes of the respective constituent elements illustrated in the drawings are arbitrarily illustrated for the sake of convenience in description, and hence the present invention is not necessarily limited thereto. That is, it should be understood that specific shapes, configurations, and characteristics described in the specification may be implemented as modified from one embodiment to another modified without departing from the spirit and scope of the prevent disclosure, and positions or arrangements of individual constituent elements may be modified without departing from the spirit and scope of the prevent disclosure. Therefore, detailed descriptions to be described below should be construed as non-limitative senses, and the scope of the present invention should be understood to include appended claims and their equivalents.

Vehicular Suspension Arm according to an Embodiment of the Present Invention

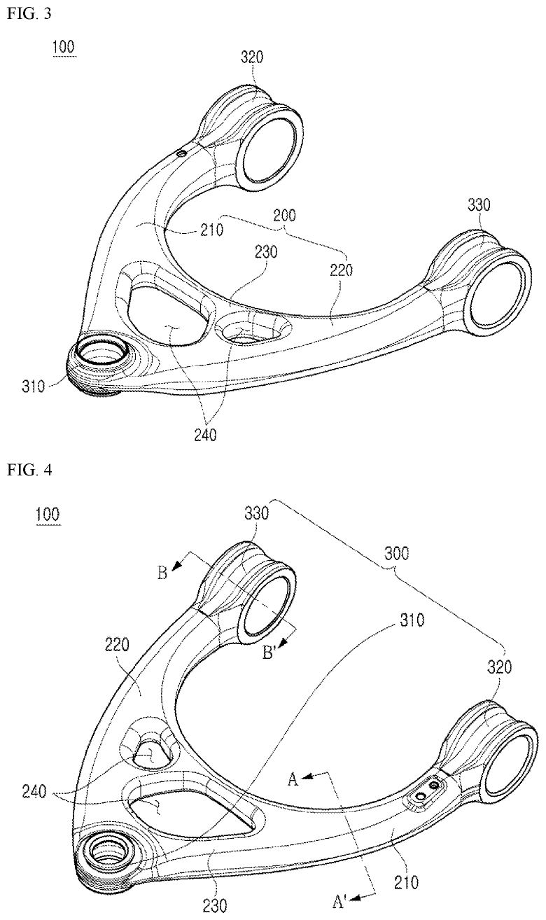

Referring to FIGS. 3 to 7, there is exemplarily illustrated a vehicular suspension arm (upper arm) 100 according to an embodiment of the present invention. The vehicular suspension arm 100 according to an embodiment of the present invention may be configured such that one side of the vehicular suspension arm 100 is connected to a wheel of a vehicle and the other side thereof is connected to a vehicle body of the vehicle, thus performing a function to couple the wheel of the vehicle to the vehicle body so as to control the motion of the wheel, like a typical vehicular suspension arm.

According to an embodiment of the present invention, the vehicular suspension arm 100 may comprise a body portion 200 located in the central portion of the vehicular suspension arm 100, and a mounting portion 300 provided at one end of the body portion 200 and used to connect the vehicular suspension arm 100 to the wheel or the vehicle body.

According to an embodiment of the present invention, the body portion 200 constitutes a basic body of the vehicular suspension arm 100 according to an embodiment of the present invention. When the vehicular suspension arm 100 according to an embodiment of the present invention is formed as an upper arm of a suspension device as illustrated in the drawings, the body portion 200 may be formed in a U-shape as a whole or a similar shape. For example, as illustrated in FIGS. 3 and 4, the body portion 200 may be configured to have a U-shaped structure as a whole, comprising two leg portions 210 and 220 that extend to one side, and a joint portion 230 that connects the two leg portions 210 and 220. In addition, the joint portion 230, which is formed to have an area wider than the two leg portions 210 and 220, may be provided with at least one through-bore 240 to reduce the weight of the vehicular suspension arm 100.

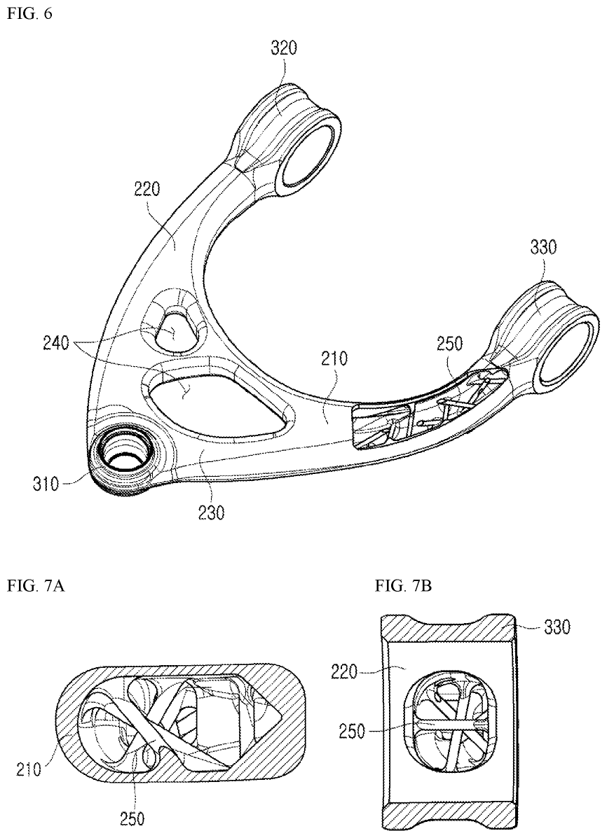

According to an embodiment of the present invention, the body portion 200 may be formed to have a hollow closed-box-section structure as a whole whose interior is empty. For example, as illustrated in FIGS. 6 and 7, the vehicular suspension arm 100 according to an embodiment of the present invention may have a configuration in which an empty space is formed inside the vehicular suspension arm 100, wherein the empty space mayo be entirely enclosed by the body portion 200 so as to form a complete hollow closed-box-section structure (for example, see the cross-sectional structure illustrated in FIG. 7A). According to an embodiment of the present invention, such a closed-box-section structure may be preferably formed throughout the body portion 200 to ensure a relatively high rigidity. Such an internal hollow structure can reduce the weight of the vehicular suspension arm 100 according to an embodiment of the present invention. In addition, the rigidity requirement required for the vehicular suspension arm 100 can be sufficiently ensured due to the closed-box-section structure.

According to an embodiment of the present invention, the body portion 200 may comprise at least one reinforcing rib 250 extending between inner circumferential surfaces of the body portion 200 in the hollow inner space formed by the closed-box-section structure. According to an embodiment of the present invention, the reinforcing rib 250 may be formed in a bar shape extending from one side to another side of the inner circumferential surface of the body portion 200. A plurality of reinforcing ribs may be provided in the hollow inner space of the body portion 200 to form a lattice structure inside the body portion 200 (see FIGS. 6 and 7). According to an embodiment of the present invention, the reinforcing rib 250 may be formed to have various cross-sectional structures, such as cylindrical, polygonal and the like. In order to ensure sufficient rigidity of the body portion 200, the reinforcing rib 250 may be formed to extend at an angle ranging from 5 degrees to 175 degrees with respect to the inner circumferential surface of the body portion 200. As described above, by forming the reinforcing rib 250 in the hollow inner space of the body portion 200, which is formed by the closed-box-section structure, it is possible to further enhance the rigidity of the body portion 200 and further increase the rigidity of the vehicular suspension arm 100.

According to an embodiment of the present invention, the mounting portion 300 may be provided on one side of the body portion 200 described above to perform the function of connecting the vehicular suspension arm 100 according to an embodiment of the present invention to the wheel or the vehicle body.

According to an embodiment of the present invention, the vehicular suspension arm 100 may be configured to comprise at least one wheel-side mounting portion (first mounting portion 310) to be connected to the wheel of the vehicle in one end portion of the body portion 200 (for example, an end portion of the joint portion 230), and at least one vehicle-body-side mounting portion (second mounting portion 320 and third mounting portion 330) to be connected to the vehicle body in another end portion of the body portion 200 (for example, end portion of the two leg portions 210 and 220).

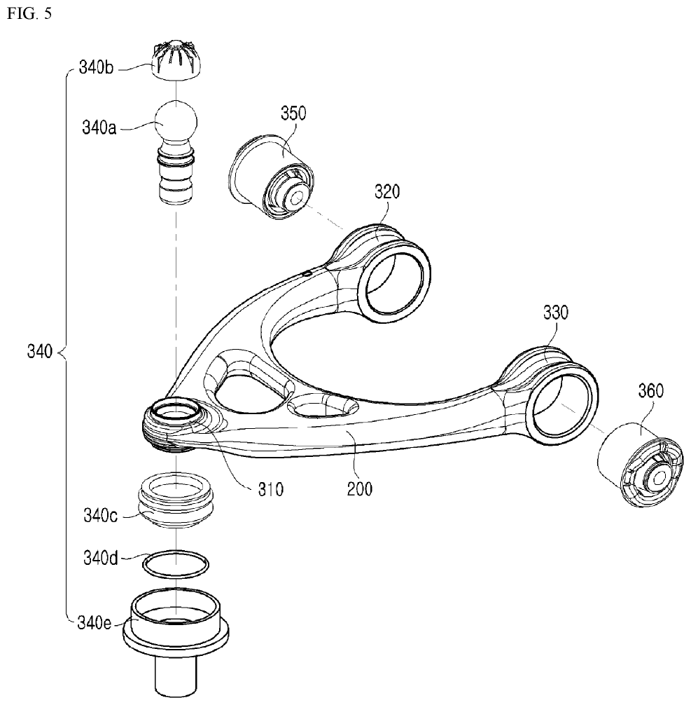

According to an embodiment of the present invention, the first mounting portion 310 may be configured to receive a ball joint 340 and be coupled to a steering knuckle the like connected to the wheel. As illustrated in FIG. 5, the ball joint 340 mounted to the first mounting portion 310 may be configured with a ball stud 340a comprising a ball member formed on one side thereof; a bolt seat 340b that surrounds and supports the ball member of the ball stud 340a; a dust cover 340c that covers around the ball stud 340a to prevent introduction of external foreign matters into the ball stud 340a; a cling lip 340d that fixes the dust cover 340c; a protector 340e that covers an upper portion of the ball stud 340a; and the like. The first mounting portion 310 receives and supports the ball member of the ball stud 340a, thus functioning to assist relative movements between parts connected to the ball joint 340.

According to an embodiment of the present invention, the second mounting portion 320 and the third mounting portion 330 may be formed at another end portion of the vehicular suspension arm 100 to connect the vehicular suspension arm 100 to the vehicle body. To do this, the second mounting portion 320 and the third mounting portion 330 may be configured such that bushings 350 and 360 used to connect the vehicular suspension arm 100 to the vehicle body are coupled to the second mounting portion 320 and the third mounting portion 330, respectively, as illustrated in FIG. 5.

For example, in the embodiment of the vehicular suspension arm 100 illustrated in the drawings, the second mounting portion 320 and the third mounting portion 330 may be formed in the form of a circular bushing pipe whose central portion is opened such that the bushings 350 and 360 are respectively inserted into and coupled to the central portions of the second mounting portion 320 and the third mounting portion 330 in a direction that is approximately perpendicular to the ball joint 340. The vehicular suspension arm 100 may be connected to the vehicle body via the bushings 350 and 360 coupled to the second mounting portion 320 and the third mounting portion 330.

Further, as illustrated in FIG. 7B, according to an embodiment of the present invention, the second mounting portion 320 and the third mounting portion 330 may be configured such that the opened central portions into which the bushings 350 and 360 are mounted are in communication with the hollow inner space of the body portion 200. Thus, when the vehicular suspension arm 100 according to an e embodiment of the present invention is manufactured through a sand casting (to be described below), the second mounting portion 320 and the third mounting portion 330 may be easily formed integrally with the body portion 200.

However, the structures of the mounting portions (the first mounting portion 310, the second mounting portion 320 and the third mounting portion 330) of the vehicular suspension arm 100 according to an embodiment of the present invention are not limited to those illustrated in the drawings, but may be formed in various shapes as long as they can connect the vehicular suspension arm 100 to the wheel and/or the vehicle body.

As described above, in the vehicular suspension arm 100 according to an embodiment of the present invention, since the body portion 200 constituting the basic body has the hollow inner space and is formed in the closed-box-section structure in which the metal member forming the body portion 200 surrounds the hollow inner space, the vehicular suspension arm 100 may have a high rigidity due to the body portion 200 of the closed-box-section structure.

In particular, the vehicular suspension arm 100 according to an embodiment of the present invention is configured such that the body portion 200 has a complete closed-box-section structure as a whole without welding or the like. Thus, it is possible to reduce the weight of the vehicular suspension arm while enhancing the rigidity thereof in an efficient manner, as compared with the suspension arm for a vehicle in the related art in which the closed-box-section structure is formed by connecting plate members through welding. Further, it is possible to simplify the manufacturing process of the vehicular suspension arm.

Further, in the vehicular suspension arm 100 according to an embodiment of the present invention, the body portion 200 and the mounting portions 300 of the vehicular suspension arm 100 can be integrally formed at once through the sand casting. This makes it possible to further improve the rigidity of the vehicular suspension arm 100 and ease of manufacturing of the vehicular suspension arm 100.

The complete closed-box-section structure formed in the body portion 200 of the vehicular suspension arm 100 according to an embodiment of the present invention may be implemented through a manufacturing method described below. Such a manufacturing method will be described in detail below.

Method of Manufacturing Vehicular Suspension Arm according to Embodiment of the Present Invention

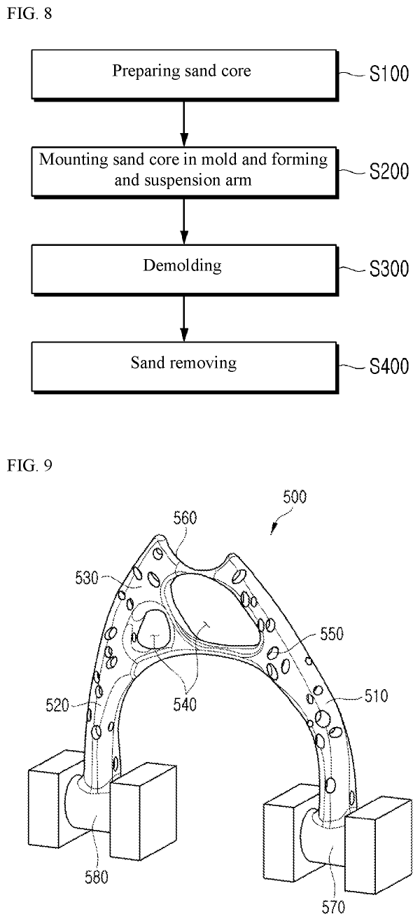

Referring to FIG. 8, there is exemplarily illustrated a flowchart for explaining the manufacturing method of the vehicular suspension arm according to an embodiment of the present invention. As illustrated in FIG. 8, the manufacturing method of the vehicular suspension arm according to an embodiment of the present invention may comprise: a sand core preparation operation S100 of forming a sand core as a basic frame; a sand core mounting and suspension arm forming operation S200 of mounting the sand core in a mold and then injecting a molten metallic material into the mold to form a suspension arm; a demolding operation S300 of separating the formed suspension arm from the mold; and a sand removing operation S400 of removing the sand core adhered to the demolded suspension arm and producing the suspension arm, and the like.

According to an embodiment of the present invention, the sand core preparation operation S100 is an operation of forming an inner core body to be used to form the vehicular suspension arm 100 according to an embodiment of the present invention through a sand casting. A sand core 500 may be formed in a shape corresponding to the vehicular suspension arm 100 according to an embodiment of the present invention.

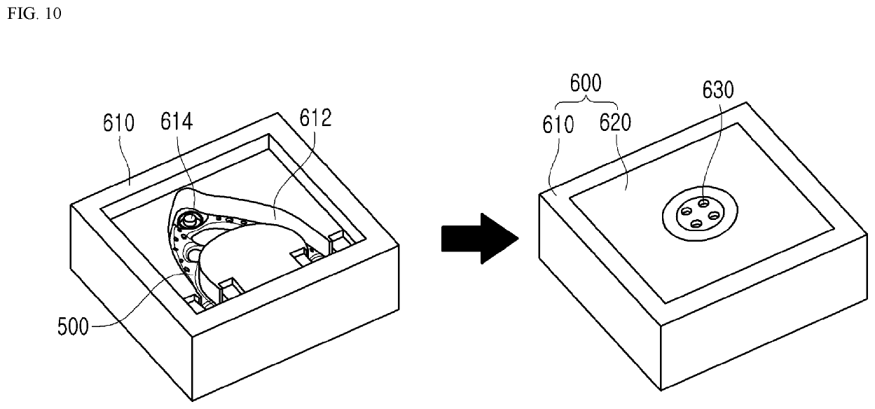

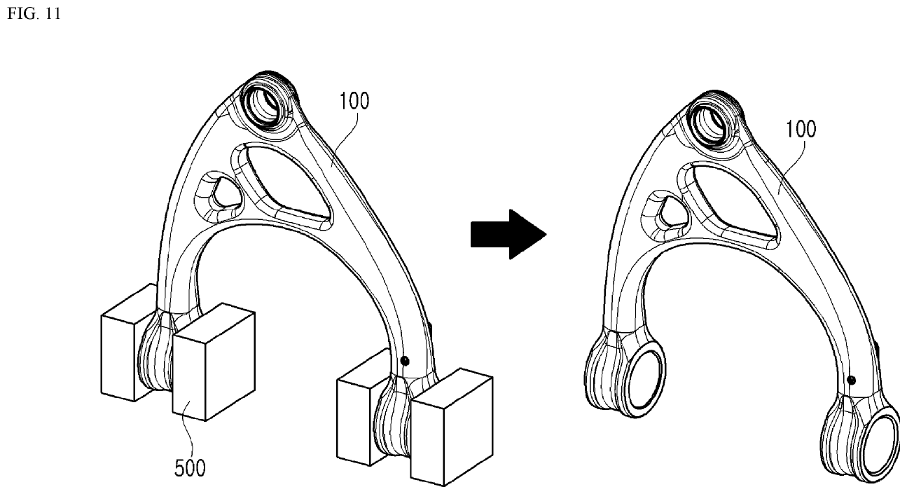

For example, as illustrated in FIG. 9, by forming the sand core 500 in such a size as to be matched to the hollow inner space provided in the vehicular suspension arm 100 according to an embodiment of the present invention, when a molten metallic material, such as aluminum, is injected in a subsequent operation, the injected metallic material is allowed to enclose an outer circumferential surface of the sand core 500 to form the vehicular suspension arm 100 according to an embodiment of the present invention. The sand core 500 may comprise two sand core leg portions 510 and 520, and a sand core joint portion 530 connecting the two sand core leg portions 510 and 520. The sand core joint portion 530 may be configured to comprise at least one sand core through-bore 540 corresponding to the through-bore 240 of the vehicular suspension arm 100. In addition, the sand core 500 may be configured to comprise at least one through-hole 550 provided in the two sand core leg portions 510 and 520 and the sand core joint portion 530 and into which the molten metallic material is inserted to form the reinforcing rib 250 of the vehicular suspension arm 100.

Further, a first-mounting-portion forming portion 560 of forming the first mounting portion 310, in which the ball joint 340 is accommodated, may be provided at one end portion of the sand core 500. A second-mounting-portion forming portion 570 and a third-mounting-portion forming portion 580 of forming the second mounting portion 320 and the third mounting portion 330 may be provided at another end portion of the sand core 500.

For example, in the case of the embodiment illustrated in the drawings, the first mounting portion 560 may be formed to provide a predetermined space portion in which the first mounting portion 310 can be formed. For example, a protrusion 614 for forming the first mounting portion 310 may be provided in a mold to which the sand core 500 is mounted as illustrated in FIG. 10, and the first mounting portion 310 may be formed on one side of the body portion 200 in the subsequent sand core mounting and suspension arm forming operation S200. Each of the second-mounting-portion forming portion 570 and the third-mounting-portion forming portion 580 is formed in a structure having a cylindrical portion extending in a direction in which the bushings 350 and 360 are respectively mounted to the second mounting portion 320 and the third mounting portion 330 (that is, along a direction in which bushing mounting holes into which the bushings350 and 360 are mounted are opened). In the subsequent core mounting and suspension arm forming operation S200, each of the second mounting portion 320 and the third mounting portion 330 may be formed around the cylindrical portion.

However, the mounting-portion forming portions (the first-mounting-portion forming portion560, the second-mounting-portion forming portion 570 and the third-mounting-portion forming portion 580) provided in the sand core 500 are not limited to structures illustrated in the drawings, but may be implemented in various forms corresponding to a structure to which the suspension arm is mounted.

Further, according to an embodiment of the present invention, the sand core 500 may be manufactured using a 3D printer so as to be able to easily design, in a shape-optimized structure, a complex structure provided with the plurality of through-holes 550 for forming the reinforcing ribs 250.

Next, the sand core mounting and suspension arm forming operation S200 is an operation of forming the suspension arm by placing the sand core 500 in a mold 600 prepared in advance and then injecting the molten metallic material into the mold 600. For example, as illustrated in FIG. 10, the sand core mounting and suspension arm forming operation S200 may comprise: inserting the sand core 500 into a lower mold 610 having a recess 612 in which the sand core 500 can be inserted; covering the lower mold 610 with an upper mold 620; and injecting the molten metallic material, such as aluminum, into the mold through an inlet 630 to form the suspension arm. In this case, the lower mold 610 may be configured to comprise the protrusion 614 for forming the first mounting portion 310, and the first mounting portion 310 may be configured to comprise a ball joint mounting portion to which the ball joint 340 is mounted (the first mounting portion 310 in the case of the embodiment described with reference to the drawings).

Next, the demolding operation S300 is an operation of separating the formed suspension arm product from the molds. In the demolding operation S300, the suspension arm product formed by injecting the molten metallic material and the sand core 500 bonded to the formed suspension arm product are separated from the molds.

Next, the sand removing operation S400 is an operation of removing the sand core 500 from the demolded suspension arm product, and leaving merely the vehicular suspension arm 100 which is a final product. According to an embodiment of the present invention, the sand removing operation S400 may be performed using vibration mode of applying vibration through a conveyor or the like to remove the sand core, an air injection mode of injecting air through the through-holes formed in the suspension arm to remove the sand core, a solvent immersion mode of immersing a product in a solution, which can melt the sand core, to remove the sand core, or the like.

As described above, through the sand casting using the sand core 500, it is possible to easily form the body portion 200 of the vehicular suspension arm 100 having a complete closed-box-section structure in which the hollow inner space is defined. This makes it possible to manufacture the vehicular suspension arm 100 that can meet the rigidity requirement required for the suspension device while reducing the weight of the product and simplifying the manufacturing process.

Furthermore, according to the above-described manufacturing method, it is possible to form a complete closed-box-section structure in the body portion 200 of the vehicular suspension arm 100, and to integrally form the reinforcing ribs 250 to extend from one side to another side of the inner surface of the body portion having the hollow inner space formed by the closed-box-section structure. This further improves the rigidity of the vehicular suspension arm 100.

Further, according to the above-described manufacturing method, the body portion 200 and the mounting portion 300 (the first mounting portion 310 connected to the wheel, and the second mounting portion 320 and the third mounting portion connected to the vehicle body) which constitute the vehicular suspension arm 100 may be formed in an integrated one-piece structure as a whole. This further improves the rigidity of the vehicular suspension arm 100 and also omits a process of forming additional mounting portions and coupling the additional mounting portions to the body portion through welding or the like. Therefore, it is possible to simplify the manufactured process of the vehicular suspension arm 100.

While the present invention has been described above by way of particular features such as specific components and the like, and exemplary embodiments, these embodiments are provided to further facilitate overall understanding of the present invention, and the present invention is not limited thereto. Various modifications and variations may be made from the above descriptions by those skilled in the art. For example, although the vehicular suspension arm according to an embodiment of the present invention has been described with the embodiment in which the vehicular suspension arm is formed as the upper arm of the suspension device, the vehicular suspension arm according to an embodiment of the present invention may also be applied to the lower arm of the suspension device.

Therefore, the spirit of the present invention should not be limited to the above-described embodiments, and not only the append claims but also all those modified equally or equivalently to the claims are intended to fall within the scope of the spirit of the present invention.

What is claimed is:

1. A suspension arm for a vehicle used for a suspension device of the vehicle, the suspension arm for a vehicle comprising:
a body portion constituting a basic body of the suspension arm; and
a mounting portion formed in one end of the body portion and configured to connect the suspension arm to a wheel or a vehicle body of the vehicle,
wherein the body portion has a closed-box-section structure in which a hollow inner space is defined, and
wherein the closed-box-section structure is configured such that the body portion is formed to integrally extend around the hollow inner space.

2. The suspension arm for a vehicle of claim 1, wherein the closed-box-section structure is formed throughout the body portion.

3. The suspension arm for a vehicle of claim 1, wherein at least one reinforcing rib is provided in the hollow inner space defined inside the body portion.

4. The suspension arm for a vehicle of claim 3, wherein the at least one reinforcing rib is formed in a bar shape that extends between inner circumferential surfaces of the body portion.

5. The suspension arm for a vehicle of claim 3, wherein the at least one reinforcing rib comprises a plurality of reinforcing ribs provided in the hollow inner space defined inside the body portion to form a lattice structure inside the hollow inner space.

6. The suspension arm for a vehicle of claim 3, wherein the at least one reinforcing rib is formed in a bar shape that extends at an angle ranging from 5 degrees to 175 degrees with respect to an inner circumferential surface of the body portion.

7. The suspension arm for a vehicle of claim 1, wherein the mounting portion comprises at least one wheel-side mounting portion connected to the wheel and at least one vehicle-body-side mounting portion connected to the vehicle body, and
wherein the body portion and the mounting portion are formed to have a single integrated structure.

8. The suspension arm for a vehicle of claim 1, wherein the suspension arm is formed by injecting a molten metallic material into a mold in a state in which a sand core formed to have a structure corresponding to the suspension arm is mounted to the mold.

9. The suspension arm for a vehicle of claim 8, wherein the molten metallic material forming the suspension arm is aluminum.

10. A method of manufacturing a suspension arm for a vehicle used for a suspension device of a vehicle, the method comprising:
a sand core preparation operation of forming a sand core serving as a basic frame;
a sand core mounting and suspension arm forming operation of mounting the sand core in a mold and subsequently injecting a molten metallic material into the mold to form the suspension arm;
a demolding operation of separating the molded suspension arm from the mold; and
a sand removing operation of removing the sand core adhered to the demolded suspension arm.

11. The method of claim 10, wherein in the sand core preparation operation, the sand core is formed to have at least one through-hole for forming a reinforcing rib, and
wherein the reinforcing rib is formed to extend between inner circumferential surfaces of a body portion of the suspension arm by injecting the molten metallic material into the through-hole.

12. The method of claim 10, wherein in the sand core preparation operation, the sand core is formed using a 3D printer.

13. The method of claim 10, wherein the sand core mounting and suspension arm forming operation comprises: inserting the sand core in a recess provided in a lower mold and, wherein the recess has a shape corresponding to the sand core; covering the lower mold with an upper mold; and injecting the molten metallic material into the mold to form the suspension arm.

14. The method of claim 13, wherein the molten metallic material injected in the sand core mounting and suspension arm forming operation is a molten aluminum material.

15. The method of claim 10, wherein in the sand removing operation, the sand core is removed using any of a vibration mode of applying vibration to remove the sand core, an air injection mode of injecting air to remove the sand core, and a solvent immersion mode of immersing a product in a solution capable of melting the sand core to remove the sand core.
